(19) United States
(12) Patent Application Publication
(10) Pub. No.: US 2025/0065864 A1
(43) Pub. Date: Feb. 27, 2025

(54) SYSTEMS AND METHODS FOR CUSTOMIZED CALIBRATION UPDATES

(71) Applicant: Cummins Inc., Columbus, IN (US)

(72) Inventors: Bruce Li, Beijing (CN); Shen Ming, Beijing (CN); Yunfei Gong, Beijing (CN); Yuchen Yang, Beijing (CN); Sean Qu, Beijing (CN); Yifeng Shen, Beijing (CN); Kiki Li, Beijing (CN); Xuewei Wang, Beijing (CN)

(73) Assignee: Cummins Inc., Columbus, IN (US)

(21) Appl. No.: 18/725,030

(22) PCT Filed: Dec. 23, 2022
(86) PCT No.: PCT/IB2022/000788

§ 371 Date: Jun. 27, 2024

(30) Foreign Application Priority Data
Dec. 29, 2021 (CN) 202111640534.7

(51) Int. Cl. B60W 20/16; B60W 10/06; B60W 10/08; B60W 10/10

(52) U.S. Cl. CPC B60W 20/16; B60W 10/06; B60W 10/08; B60W 10/10; B60W 2530/10; B60W 2555/40; B60W 2556/45; B60W 2710/06; B60W 2710/08; B60W 2710/1005

(57) ABSTRACT

A computing system coupled to at least one vehicle includes a processing circuit comprising one or more processors coupled to one or more memory devices storing instructions therein that, when executed by the one or more processors, cause the processing circuit to: obtain, from a third-party remote computing system, first information; receive, from a vehicle, vehicle information comprising a calibration identifier, generate, based on the first information and the vehicle information, custom calibration information; and transmit, over a network, the custom calibration information to the vehicle that replaces at least a portion of the vehicle information stored in at least one vehicle controller of the vehicle.

### CROSS-REFERENCE TO RELATED APPLICATION

This application claims the benefit of and priority to C.N. patent application Ser. No. 20/211,1640534.7, filed Dec. 29, 2021, titled “SYSTEMS AND METHODS FOR CUSTOMIZED CALIBRATION UPDATES,” which is incorporated herein by reference in its entirety.

### TECHNICAL FIELD

The present disclosure relates to customized calibration updates for vehicle controller(s) to improve vehicle engine, component, and/or other system efficiency and/or performance.

### BACKGROUND

Vehicles include various components including an engine, a controller, a braking system, exhaust aftertreatment systems, a transmission, a heating ventilation and air conditioning system, and so on. The controller(s) of the vehicle may include operating software. The operating software can define parameters that control how certain systems/components may operate (e.g., define fuel injection quantities/timing at certain instances, define allowed engine speeds/torques, define cruise control droop settings, and so on). However, the operating software and defined parameters are typically generic to the engine, vehicle, and/or other vehicle system/devices without regard to operating conditions of the vehicle. As a result, the performance of the vehicle, engine, and/or other vehicle systems/devices may differ between multiple vehicles that share the same operating software and defined parameters. This can result in decreased performance across these multiple vehicles.

### SUMMARY

One embodiment relates to a computing system coupled to at least one vehicle. The computing system comprises: a processing circuit comprising one or more processors coupled to one or more memory devices storing instructions therein that, when executed by the one or more processors, cause the processing circuit to: obtain, from a third-party remote computing system, first information; receive, from a vehicle, vehicle information comprising a calibration identifier; generate, based on the first information and the vehicle information, custom calibration information; and transmit, over a network, the custom calibration information to the vehicle that replaces at least a portion of the vehicle information stored in at least one vehicle controller of the vehicle.

In some implementations, the instructions, when executed by the one or more processors, further cause the processing circuit to: receive, from a client computing device associated with the vehicle, a desired operating characteristic for the vehicle; and generate the custom calibration information specific to the received desired operating characteristic for the vehicle. In some implementations, the desired operating characteristic comprises at least one of an improved fuel economy, an increased usage of an electric motor in place of an internal combustion engine, or a reduction in transmission shift events. The desired operating characteristic is received from the at least one vehicle controller storing the vehicle information.

In some implementations, the custom calibration information is specific to a condition received for the vehicle. The condition comprises at least one of a defined route for the vehicle, a load for the vehicle, a region of travel for the vehicle, a season of travel for the vehicle, or an altitude of travel for the vehicle. In some implementations, the calibration identifier is a base calibration identifier identifying an operating software package specific to the vehicle. In some embodiments, the base calibration identifier is specific to an engine of the vehicle.

In some implementations, the custom calibration information includes specific parameters based on the calibration identifier. The specific parameters may comprise at least one of user operation parameters, engine control parameters, or vehicle device parameters. In some implementations, to generate the custom calibration information, the instructions, when executed by the one or more processors, further cause the processing circuit to: identify at least one similar vehicle based on at least one of a base calibration identifier or an equipment platform identifier and a desired operating characteristic; identify one or more key parameters of the identified similar vehicle; and transmit, over the network, the one or more key parameters in the custom calibration information to the vehicle.

In some implementations, the vehicle information comprises at least one of a vehicle location, a vehicle route, a vehicle type, or vehicle operating information. In some implementations, the first information comprises at least one of a weather input, traffic information for the vehicle, or a market requirement.

Another embodiment relates to a method. The method includes: obtaining, by one or more processors coupled to one or more memory devices, from a third-party remote computing system, first information; receiving, by the one or more processors, from a vehicle, vehicle information comprising a calibration identifier; generating, by the one or more processors, based on the first information and the vehicle information, custom calibration information; and transmitting, by the one or more processors, over a network, the custom calibration information to the vehicle that replaces at least a portion of the vehicle information stored in at least one vehicle controller of the vehicle.

In some implementations, the method further comprises receiving, by the one or more processors, from a client computing device associated with the vehicle, a desired operating characteristic for the vehicle; and generating, by the one or more processors, the custom calibration information specific to the received desired operating characteristic for the vehicle. In some implementations, the desired operating characteristic comprises at least one of an improved fuel economy, a reduction in exhaust gas emissions of a certain exhaust gas constituent, an increased usage of an electric motor in place of an internal combustion engine, or a reduction in transmission shift events. In some implementations, the desired operating characteristic is received from the at least one vehicle controller storing the vehicle information. In some implementations, the custom calibration information is specific to a condition received for the vehicle, and wherein the condition comprises at least one of a defined route for the vehicle, a load for the vehicle, a region of travel for the vehicle, a season of travel for the vehicle, or an altitude of travel for the vehicle.

Another embodiment relates to a system coupled to a computing system. The system includes at least one controller including a processing circuit comprising one or more processors coupled to one or more memory devices storing instructions therein that, when executed by the one or more processors, cause the processing circuit to: transmit vehicle information regarding a vehicle comprising a calibration identifier to the computing system; and receive, from the computing system over a network, custom calibration information that replaces at least a portion of the vehicle information stored in the at least one vehicle controller of the vehicle, the custom calibration information based on first information obtained from a third-party remote computing system and the vehicle information.

In some implementations, the custom calibration information is specific to a desired operating characteristic received from a client computing device. In some implementations, the desired operating characteristic comprises at least one of an improved fuel economy, a reduction in exhaust gas emissions of a certain exhaust gas constituent, an increased usage of an electric motor in place of an internal combustion engine, or a reduction in transmission shift events.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Additionally, one or more features of an aspect of the invention may be combined with one or more features of a different aspect of the invention. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

FIG. 1 is an operational view of a customized calibration computing system, according to an example embodiment.

FIG. 2 is a block diagram of the vehicle controller, remote computing system, and third-party of FIG. 1, according to an example embodiment.

FIG. 3 is a flow diagram of a method of providing customized calibration information to a vehicle, according to an example embodiment.

FIGS. 4A-J are illustrations of user interfaces, according to an example embodiment.

### DETAILED DESCRIPTION

The various concepts introduced above and discussed in greater detail below may be implemented in any number of ways, as the concepts described are not limited to any particular manner of implementation. Examples of specific implementations and applications are provided primarily for illustrative purposes.

Referring to the Figures generally, systems, apparatuses, and methods for generating and providing custom calibration are shown and described herein, according to various embodiments. As described herein, a remote computing system is provided that is coupled, via a network to various devices, including at least one of a third-party (e.g., a third-party remote computing system or third-party source), at least one vehicle, and at least one client computing device (e.g., a user interface (UI) device). The vehicle includes at least a vehicle controller and an operator input/output (I/O) device among potentially other systems and devices. The vehicle controller is configured to control, at least partly, operation of the vehicle and components/systems therein (e.g., an engine). For instance, the vehicle controller(s) may control, at least partly, an acceleration of the vehicle, engaging brakes, heating or cooling vehicle component(s), updating/tuning/calibrating vehicle information, etc. The remote computing system is structured to communicate information (e.g., data, signals, etc.) with one or more devices. In particular, the remote computing system is structured to receive and/or obtain information from the third-party. The information from the third-party can include, for instance, real-time and/or forecasted weather, traffic status, market requirements, etc. The remote computing system receives vehicle information from the vehicle. The vehicle information may include any information related to the vehicle, such as a location, a route, power-takeoff information (e.g., excavator, crane, etc.), operation information (e.g., velocity, acceleration, engine speed, fuel consumption, transmission status, component temperature, charge pressure, etc.), among others.

The remote computing system performs an analysis on the data received from various devices, such as the third-party source, the vehicle, and/or the client computing device. The remote computing system compares vehicle information between different vehicles. Based on the vehicle information, one or more parameters may not be optimized for certain desired operating characteristics (e.g., fuel economy, performance, etc.). To optimize, the remote computing system identifies at least one vehicle similar to a respective vehicle based on comparable vehicle information, such as at least one of an operation condition of the vehicle, a vehicle type, a route, a location or region of operation, etc. For example, the remote computing system can determine or identify a second vehicle (e.g., or other vehicles) with an optimized operating characteristic (e.g., improved fuel economy, reliability, braking, acceleration, speed, transmission shifts, etc.) relative to a first vehicle. The remote computing system obtains one or more parameter settings from the second vehicle for integration with the first vehicle to satisfy or attempt to satisfy/achieve a desired operating characteristic (or parameter settings). The remote computing system generates customized calibration information based at least on the vehicle information of the first vehicle and information from the third-party, and communicates the customized calibration information to the first vehicle, thereby integrating certain parameter settings for specific operating characteristic optimization (i.e., over-the-air (OTA) update). In some cases, the remote computing system can use predetermined settings or calibration standards for optimizing an operating characteristic. Hence, the systems and methods of the present disclosure can analyze parameters, vehicle information, settings, etc. of various vehicles to determine optimal settings for a particular vehicle to improve the vehicle operation (e.g., improved efficiency, fuel economy, performance, reliability, etc.) via OTA calibration.

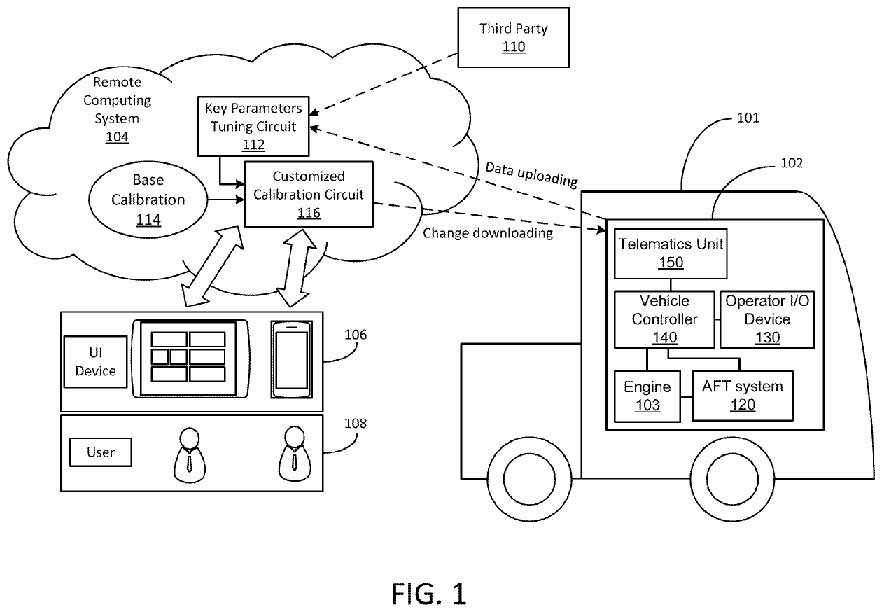

Referring now to FIG. 1, an operational view of a customized calibration system 100 is illustrated, according to an exemplary embodiment. The system 100 includes at least one vehicle 101, a remote computing system 104, at least one user interface (UI) device 106 (e.g., client computing device), at least one user 108 (e.g., operator or administrator) associated with the UI device 106, and at least one third-party 110 (e.g., third-party source or third-party remote computing system).

The vehicle 101 may be included as part of a fleet of vehicles and/or be an independent vehicle that is unassociated with a fleet. The vehicle is shown to include a system 102 (e.g., vehicle system). The system 102 may include an engine 103, an aftertreatment system 120, an operator I/O device 130, a vehicle controller 140, and/or a telematics unit 150, among potentially other components and/or systems. In other embodiments, the telematics unit 150 may be excluded. Further, in still other embodiments, fewer/more components and/or systems may be included with the vehicle 101. The one or more components (e.g., the engine 103, aftertreatment system 120, operator I/O device 130, vehicle controller 140, and/or telematics unit 150) of the system 102 can include or be composed of hardware, software, or a combination of hardware and software components. The one or more components can be coupled with each other. According to one embodiment and as shown, the system 102 is embodied in a vehicle 101. The vehicle 101 may include an on-road or an off-road vehicle including, but not limited to, line-haul trucks, mid-range trucks (e.g., pick-up trucks), sedans, coupes, etc. Additional off-highway applications can include tanks, airplanes, boats, power generators or gensets, construction equipment (e.g., excavators, wheel loaders, cranes, forklifts, etc.), agricultural equipment (e.g., tractors, combines, sprayer, etc.), and so on. The system 102 may also be implemented with stationary pieces of equipment like power generators or gen-sets. The system 102 may be embodied in one or more other vehicles that are similar to vehicle 101.

The engine 103 may be structured as any type of engine (e.g., compression-ignition internal combustion engine that utilizes diesel fuel, spark-ignition, etc.) that utilizes any type of fuel (e.g., gasoline, natural gas, etc.). In some implementations, the engine 103 may be or include an electric motor (e.g., a hybrid drivetrain). One or more batteries may be included to provide power to the electric motor to propel the vehicle. In some embodiments, the vehicle may be configured as a full electric vehicle, a fuel cell powered vehicle, or another type of vehicle. As described herein, if a fuel cell is used, the optimization goal can be Hydrogen consumption by improving motor control calibration.

The engine 103 includes one or more cylinders and associated pistons. Air from the atmosphere is combined with fuel, and combusted, to power the engine 103. Combustion of the fuel and air in the compression chambers of the engine 103 produces exhaust gas that is operatively vented to an exhaust pipe and to the aftertreatment system 120. In the example shown, the engine 103 is structured as a compression-ignition engine powered by diesel fuel.

The aftertreatment system 120 is coupled to the engine 103. The aftertreatment system 120 is structured to treat exhaust gases from the engine 103, which enter the aftertreatment system 120 via an exhaust pipe, in order to reduce the emissions of harmful or potentially harmful elements (e.g., reduce NOx emissions, particulate matter, SOx, CO, greenhouse gases, etc.). The aftertreatment system 120 may include various components and systems, such as a diesel oxidation catalyst (DOC), a diesel particulate filter (DPF), and a selective catalytic reduction (SCR) system. The SCR converts nitrogen oxides present in the exhaust gases produced by the engine 103 into diatomic nitrogen and water through oxidation within a catalyst. The DPF is configured to remove particulate matter, such as soot, from exhaust gas flowing in the exhaust gas conduit system. In some implementations, the DPF may be omitted. Also, the spatial order of the catalyst elements may be different.

The aftertreatment system 120 may further include a reductant delivery system which may include a decomposition chamber (e.g., decomposition reactor, reactor pipe, decomposition tube, reactor tube, etc.) to convert the reductant (e.g., urea, diesel exhaust fluid (DEF), Adblue®, a urea water solution (UWS), an aqueous urea solution, etc.) into ammonia. A diesel exhaust fluid (DEF) is added to the exhaust gas stream to aid in the catalytic reduction. The reductant may be injected by an injector upstream of the SCR catalyst member such that the SCR catalyst member receives a mixture of the reductant and exhaust gas. The reductant droplets undergo the processes of evaporation, thermolysis, and hydrolysis to form non-NOx emissions (e.g., gaseous ammonia, etc.) within the decomposition chamber, the SCR catalyst member, and/or the exhaust gas conduit system, which leaves the aftertreatment system 120. The aftertreatment system 120 may further include an oxidation catalyst (e.g., the DOC) fluidly coupled to the exhaust gas conduit system to oxidize hydrocarbons and carbon monoxide in the exhaust gas. In order to properly assist in this reduction, the DOC may be required to be at a certain operating temperature. In some embodiments, this certain operating temperature is between 200 degrees C. and 500 degrees C. In other embodiments, the certain operating temperature is the temperature at which the conversion efficiency of the DOC exceeds a predefined threshold (e.g., the conversion of NOx to less harmful compounds, which is known as the NOx conversion efficiency).

The aftertreatment system 120 includes one or more sensors (e.g., virtual and/or physical sensors). The number, placement, and type of sensors included in the aftertreatment system 120 can vary, such as based on the manufacturer of the aftertreatment system or configured operations for the aftertreatment system 120. The sensors may be NOx sensors, temperature sensors, particulate matter (PM) sensors, and/or other emissions constituents sensors. The aftertreatment system 120 (e.g., sensors) can communicate information with the vehicle controller 140, such as receiving operating instructions or transmitting sensor data, among other information to the vehicle controller 140.

The sensors may be real or virtual (i.e., a non-physical sensor that is structured as program logic in the controller that makes various estimations or determinations). For example, an emissions sensor may be a real or virtual sensor arranged to measure or otherwise acquire data, values, or information indicative of an emissions level of the aftertreatment system 120. The sensor is coupled to the engine (when structured as a real sensor), and is structured to send a signal to the vehicle controller 140. When structured as a virtual sensor, at least one input may be used by the vehicle controller 140 in an algorithm, model, look-up table, etc. to determine or estimate a parameter of the engine (e.g., power output, etc.). The other sensors may be real or virtual as well. As will be described herein, the sensors and additional sensors may provide data regarding how the particular vehicle system is operating.

The operator I/O device 130 is communicably coupled to the vehicle controller 140, such that information may be exchanged between the vehicle controller 140 and the I/O device 130, wherein the information may relate to one or more components of FIG. 1 and/or data/information from the remote computing system 104 and/or third party 110 as described herein. The operator I/O device 130 enables an operator of the system 102 (e.g., operator of the vehicle 101) to communicate with the vehicle controller 140 and one or more components of the system 102. For example, the operator I/O device 130 may include, but is not limited to, an interactive display, a touchscreen device, one or more buttons and switches, voice command receivers, etc. As alluded to above and in various alternate embodiments, the vehicle controller 140 and components described herein may be implemented with non-vehicular applications (e.g., a power generator). Accordingly, the I/O device may be specific to those applications. Via the operator I/O device, the vehicle controller 140 may provide diagnostic information, such as one or more fault codes, a malfunction indicator light (MIL), and/or other information regarding the operation of the vehicle and the systems/components thereof. For example, in some embodiments, the vehicle controller 140 may display, via the operator I/O device, a temperature of the DOC, a temperature of the engine and the exhaust gas, and various other information. In some cases, the operator I/O device 130 can include or perform features, functionalities, or operations similar to the UI device 106, such as generating and/or rendering graphical user interface (GUI) to the operator, communicating remotely to the remote computing system 104, receiving interactions from the operator, etc.

The vehicle controller 140 is structured to control the operation of the system 102 and associated sub-systems, such as the aftertreatment system 120 (and various components of each system), and the operator input/output (I/O) device 130. Because the vehicle controller 140 is communicably coupled to the systems and components of the system 102, the vehicle controller 140 is structured to receive data from one or more of the components of system 102. The structure and function of the vehicle controller 140 are further described in regard to at least FIG.

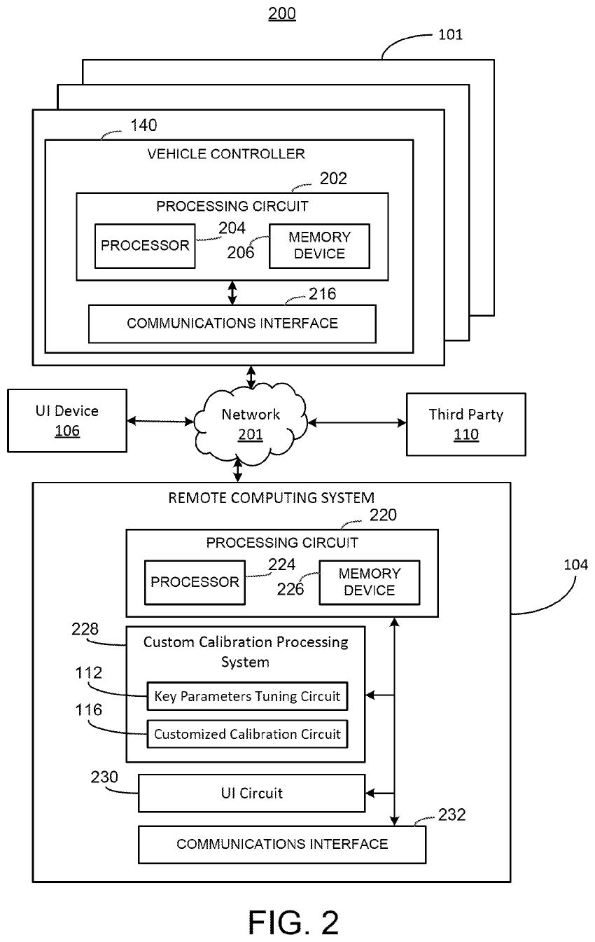

The telematics unit 150 may include, but is not limited to, one or more memory devices for storing tracked data, one or more electronic processing units for processing the tracked data, and a communications interface for facilitating the exchange of data between the telematics unit 150 and one or more remote devices (e.g., a provider/manufacturer of the telematics device, etc.). In one embodiment, the telematics unit 150 may facilitate remote updates to the vehicle controller 140 (e.g., calibration parameters, trim parameters, complete operating system software/packages, etc.). In this regard, the communications interface may be configured as any type of mobile communications interface or protocol including, but not limited to, Wi-Fi, WiMax, Internet, Radio, Bluetooth, ZigBee, satellite, radio, Cellular, GSM, GPRS, LTE, and the like. The telematics unit 150 may also include a communications interface (e.g., communications interface 216 and/or communications interface 232 shown in FIG. 2) for communicating with the vehicle controller 140 of the system 102. The communication interface for communicating with the vehicle controller 140 may include any type and number of wired and wireless protocols (e.g., any standard under IEEE 802, etc.). For example, a wired connection may include a serial cable, a fiber optic cable, an SAE J1939 bus, a CAT5 cable, or any other form of wired connection. In comparison, a wireless connection may include the Internet, Wi-Fi, Bluetooth, ZigBee, cellular, radio, etc. In one embodiment, a controller area network (CAN) bus including any number of wired and wireless connections provides the exchange of signals, information, and/or data between the vehicle controller 140 and the telematics unit 150. In other embodiments, a local area network (LAN), a wide area network (WAN), or an external computer (for example, through the Internet using an Internet Service Provider) may provide, facilitate, and support communication between the telematics unit 150 and the vehicle controller 140. In still another embodiment, the communication between the telematics unit 150 and the vehicle controller 140 is via the unified diagnostic services (UDS) protocol. All such variations are intended to fall within the spirit and scope of the present disclosure.

The third-party 110 may correspond to or be referred to as a third-party source, and is associated with a third-party computing system that may also be referred to as a third-party remote computing system. The third-party 110 associated with a third-party computing system may be coupled over the network to the remote computing system 104. The third party computing system may be a cloud computing system and/or any other type of computing system. The third-party refers to a product and/or service provider that is a third-party relative to the provider associated with the remote computing system 104. The third-party may be an information-providing source, which may include information such as weather information; road grade information, road altitude, and other terrain information; traffic information; market requirements (e.g., emissions requirements such as NOx limits for various regions, particulate matter limits for various regions, and so on); and other information that may affect the operation of the vehicle 101, among other vehicles. As described herein, the remote computing system 104 is structured to utilize this information to optimize/generate custom calibration information for one or more vehicles.

The UI device 106 refers to a device structured or configured to generate, render, and/or display a user interface (UI) (e.g., graphical user interface (GUI)) for the user 108. The UI device 106 includes various hardware or software components, or a combination of both hardware and software components. The UI device 106 may be any type of wired or wireless device, including a laptop, smartphone, tablet, desktop, etc. operated by one or more users 108. For example, the UI device 106 may be operated by a fleet manager who manages a fleet of vehicles 101. The UI device 106 may be remote to the vehicle 101 and other devices within the system 100. The UI device 106 is structured to receive inputs or an indication of interaction from the user 108. The UI device 106 includes at least one processor and a memory, e.g., a processing circuit similar to processing circuit 202 or processing circuit 220 shown in FIG. 2.

The user 108 is an operator, administrator, owner, or holder of the UI device 106 associated with the vehicle 101. The user 108 interacts with the UI device 106 to obtain information related to the vehicle 101, such as vehicle information, calibration information, performance changes to the vehicle 101 in response to initiating the calibration, among others. The user 108 can provide instructions (e.g., adjustment to one or more parameters or operations of the vehicle 101) to the remote computing system 104 and/or the vehicle 101 via the UI device 106. The user 108 can perform other tasks, such as described in further detail herein.

Still referring to FIG. 1, the remote computing system 104 is coupled to the third party 110, UI device 106, and vehicle 101. The remote computing system 104 is associated with a provider entity. The provider entity may be a service and/or product provider, such as an engine manufacturer, vehicle controller provider, and so on. In the example shown, the provider entity provides the operating platform and parameters thereof (e.g., software) for the vehicle controller 140. In some embodiments, the information provided by the third party may be stored or kept by the remote computing system 104.

Referring now to FIG. 2, a block diagram 200 of the vehicle controller 140, remote computing system 104, and third-party 110 of FIG. 1 is shown, according to an example embodiment. As shown, a network 201 is configured to couple the systems and devices together to enable an over-the-air of calibration and/or parameters defined in the calibration package of the vehicle controller 140. The network 201 can be or include computer networks such as the Internet, local, wide, metro or other area networks, intranets, satellite networks, other computer networks such as voice or data mobile phone communication networks, and combinations thereof. The network 201 may be any form of computer network that can relay information between the one or more components of the system 100. In some implementations, the network 201 may include the Internet and/or other types of data networks, such as a local area network (LAN), a wide area network (WAN), a cellular network, a satellite network, or other types of data networks. The network 201 may also include any number of computing devices (e.g., computers, servers, routers, network switches, etc.) that are configured to receive and/or transmit data within the network 201.

The vehicle controller 140 may be a part of the vehicle 101. Other vehicles may include a similar vehicle controller as the vehicle controller 140. The vehicle controller 140 may be structured as one or more electronic control units (ECU). The vehicle controller 140 may be, may be separate from, or included with at least one of a transmission control unit, an exhaust aftertreatment control unit, a powertrain control module, an engine control module, etc. For example, in some implementations, the vehicle controller 140 can include or correspond to an engine controller. In one embodiment, the components of the vehicle controller 140 are combined into a single unit. In another embodiment, one or more of the components may be geographically dispersed throughout the system. All such variations are intended to fall within the scope of the disclosure. The vehicle controller 140 is shown to include a processing circuit 202 having a processor 204 and a memory device 206, and a communications interface 216. The processing circuit 202 may be structured or configured to execute or implement the instructions, commands, and/or control processes described herein.

The processor 204 may be implemented as one or more processors, an application specific integrated circuit (ASIC), one or more field programmable gate arrays (FPGAs), a digital signal processor (DSP), a group of processing components, or other suitable electronic processing components. In some embodiments, the one or more processors may be shared by multiple circuits, such as any circuit of the vehicle controller 140 or system 102. Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory device 206 (e.g., memory, memory unit, storage device) may include one or more devices (e.g., RAM, ROM, Flash memory, hard disk storage) for storing data and/or computer code for completing or facilitating, at least some of, the various processes, layers and modules described in the present disclosure. The memory device 206 may be communicably connected to the processor 204 to provide computer code or instructions to the processor 204 for executing at least some of the processes described herein. Moreover, the memory device 206 may be or include tangible, non-transient volatile memory or non-volatile memory. Accordingly, the memory device 206 may include database components, object code components, script components, or any other type of information structure for supporting the various activities and information structures described herein.

The communications interface 216 may include any combination of wired and/or wireless interfaces (e.g., jacks, antennas, transmitters, receivers, transceivers, wire terminals) for conducting data communications with various systems, devices, or networks structured to enable in-vehicle communications (e.g., between and among the components of the vehicle) and out-of-vehicle communications (e.g., with remote computing system 104). For example and regarding out-of-vehicle/system communications, the communications interface 216 may include an Ethernet card and port for sending and receiving data via an Ethernet-based communications network and/or a Wi-Fi transceiver for communicating via a wireless communications network. The communications interface 216 may be structured to communicate via local area networks or wide area networks (e.g., the Internet) and may use a variety of communications protocols (e.g., IP, LON, Bluetooth, ZigBee, radio, cellular, near field communication). The communications interface 216 may facilitate coupling to computing devices, such as OBD tools, that enable updating/changing of the calibration packages and/or trim parameters for the vehicle controller 140. Based on the foregoing, in one embodiment, the controller 140 may communicate via the network with the remote computing system 104 and/or UI device 106 without the usage of the telematics unit. In another embodiment, the controller 140 may not include a network interface and communications with the remote computing system 104 and/or UI device 106 are via the telematics unit. The communications interface 216 facilitates coupling to the remote computing system 104 to update/calibrate/change one or more parameters and/or an operating system for the vehicle controller 140 to achieve or attempt to achieve a specific operating characteristic.

The communications interface 216 may facilitate communication between and among the vehicle controller 140 and one or more components of the system 102 (e.g., the engine 103, the aftertreatment system 120, etc.). Communication between and among the vehicle controller 140 and the components of the system 102 may be via any number of wired or wireless connections (e.g., any standard under IEEE). For example, a wired connection may include a serial cable, a fiber optic cable, a CAT5 cable, or any other form of wired connection. In comparison, a wireless connection may include the Internet, Wi-Fi, cellular, Bluetooth, ZigBee, radio, etc. In one embodiment, a controller area network (CAN) bus provides the exchange of signals, information, and/or data. The CAN bus can include any number of wired and wireless connections that provide the exchange of signals, information, and/or data. The CAN bus may include a local area network (LAN), or a wide area network (WAN), or the connection may be made to an external computer (for example, through the Internet using an Internet Service Provider).

The processing circuit 202 is structured to facilitate updating, adjusting, and/or changing one or more calibration parameters, trim parameters, and/or the software operating system (or other software features) of the vehicle controller 140. Thus, the processing circuit 202 facilitates reflashing of the vehicle controller 140, or parts thereof, such as an engine control calibration. Thus, the reflashing may include changing trim parameters, calibration parameters, and/or performing various software updates. The processing circuit 202 is structured to receive one or more calibration parameters and trim parameters. Thus, the processing circuit 202 is programmed with a calibration parameter and a trim parameter.

A “trim parameter” refers to an electronic operational setting for, e.g., the engine or a component of the system that may be adjustable by an operator or a technician. In comparison, a “calibration parameter” is typically a setting that is non-adjustable by either the operator or a technician. An example of a calibration parameter is an allowable engine temperature before causing at least one of shutting the engine down, a derate event, and triggering an indicator light. Another example of a calibration parameter may include an operating condition prescribed by a local, state, or federal mandate (e.g., an acceptable emissions level before causing an engine derate condition). A non-exhaustive list of trim parameters includes: various parameters relating to cruise control (e.g., an upper droop amount, a lower droop amount, etc.); a road speed governor limit (i.e., the maximum allowable road speed of the vehicle); an idle shut down parameter (e.g., an amount of time before an idle engine shuts down); a load based speed control parameter (e.g., a predefined engine speed for certain operating conditions, such as load); a gear down protection parameter for a light load vehicle speed and a heavy load vehicle speed (e.g., maintain the vehicle in the light load or heavy load vehicle speed to promote increased fuel economy by minimizing downshifts to promote operation of the vehicle in a top gear); and, a vehicle acceleration management feature (e.g., to limit acceleration in certain conditions to improve fuel economy). The processing circuit 202 is structured to receive one or more calibration parameters and trim parameters and store them in the memory (e.g., memory device 206) for execution/use/implementation by the vehicle controller 140. The parameters may be received from the telematics unit 150 (e.g., over the air recalibrating of one or more parameters) or directly from the remote computing system 104 via the communications interface 216 of the controller 140.

In operation and as described herein, the vehicle controller 140 receives customized calibration information from the remote computing system 104 that is generated based on, at least, vehicle information of the vehicle 101 and information from the third-party 110. The customized calibration information includes parameter adjustment information (e.g., changes or adjustments to one or more parameters).

Based on the received customized calibration information received by the vehicle controller 140 (e.g., such as an engine controller), the vehicle controller 140 adjusts operation of certain component(s) of the system 102, such as the engine 103, the aftertreatment system 120, etc. to satisfy/achieve and/or attempt to satisfy/achieve a desired operating characteristic and/or based on one or more operating conditions of the vehicle 101. For example, the generated customized calibration information may account for the weather or traffic condition on the road to dynamically adjust the maximum speed or speed limit of the vehicle 101. The customized calibration information can include a configuration to lower the maximum speed during congested traffic or certain weather condition (e.g., rainstorm, snowstorm, etc.). In some cases, the speed is limited to control the engine speed for fuel economy. In another example, for optimized fuel economy (i.e., the desired operating characteristic), the generated customized calibration information accounts for the traffic, weather, or other information from the third-party 110 for the vehicle controller 140 to decrease fuel consumption by optimizing transmission shift behavior (e.g., limiting high/max vehicle speed with lower gear configuration or numbers), optimization of coordination mode between the engine and an electric motor (in a hybrid vehicle application to, for example, rely on electric motor more than the engine reduce fuel consumption amounts), lower acceleration rates to reduce fuel consumption during these times (e.g., by remapping a throttle valve so that further depressions of an accelerator pedal do not correspond with larger fuel injections/throttle valve openings), etc. In some cases, the customized calibration information provides updates to gear-down protection parameters for leading driver shifting up, for example.

In a further example, the customized calibration information accounts for the terrain (e.g., uphill, downhill, flats, etc.) of routes for the vehicle controller 140 to prolong/maintain lower gears in uphill and/or downhill terrain, decrease A/C usage during uphill paths, increasing braking coefficient during downhill paths, etc. to enhance vehicle performance as part of the desired operating characteristic. The customized calibration information includes other parameters for vehicle optimization. In another example, in a fuel cell vehicle application, the desired operating characteristic (e.g., optimization goal) can relate to hydrogen consumption (e.g., reducing hydrogen consumption), such that the customized calibration includes control parameters associated with the this optimization goal.

The vehicle controller 140 is configured or structured to facilitate updating of the trim and/or calibration parameter(s) (and/or operating software for the controller 140). The updating may be done according to a predefined schedule or time such as periodically (e.g., weekly, monthly, etc.), before a trip (e.g., based on an indication of a route to the remote computing system 104 or the vehicle controller 140 storing parameters for predetermined routes), during a trip (e.g., changing course or different route), at random times, and/or responsive to receiving the customized calibration information from the remote computing system 104.

In one embodiment, the remote computing system 104 is structured as a cloud computing system. In another embodiment, the remote computing system 104 is structured as another type of computing system. The remote computing system 104 includes a processing circuit 220, a custom calibration processing system 228, a user interface (UI) circuit 230, and a communications interface 232. The processing circuit 220 includes a processor 224 and a memory device 226. The processing circuit 220, processor 224, memory device 226, and communications interface 232 may be similar to the processing circuit 202, processor 204, memory device 206, and communications interface 216, respectively. The custom calibration processing system 228 includes at least a key parameters tuning circuit 112 and a customized calibration circuit 116. The custom calibration processing system 228 is or refers to a custom calibration circuit, which is a circuit with features, functionalities, or operations of the key parameters tuning circuit 112 and/or the customized calibration circuit 116.

In one configuration, the key parameters tuning circuit 112, customized calibration circuit 116, and UI circuit 230 can be embodied as machine or computer-readable media that stores instructions that are executable by a processor, such as processor 224, and stored in a memory device, such as memory device 226. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the key parameters tuning circuit 112, customized calibration circuit 116, and/or UI circuit 230 are embodied as hardware units, such as electronic control units. As such, the one or more may be embodied as one or more circuitry components including, but not limited to, processing circuitry, network interfaces, peripheral devices, input devices, output devices, sensors, etc. In some embodiments, the one or more circuits may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the one or more circuits may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The one or more circuits may also include programmable hardware devices such as field programmable gate arrays, programmable array logic, programmable logic devices or the like. The one or more circuits may include one or more memory devices for storing instructions that are executable by the processor(s) of the individual circuits (e.g., key parameters tuning circuit 112, customized calibration circuit 116, and/or UI circuit 230). The one or more memory devices and processor(s) may have the same definition as provided below with respect to the memory device 226 and processor 224. In some hardware unit configurations, the one or more circuits may be geographically dispersed throughout separate locations in, for example, the remote computing system 104. Alternatively and as shown, the one or more circuits may be embodied in or within a single unit/housing for instance of the remote computing system 104.

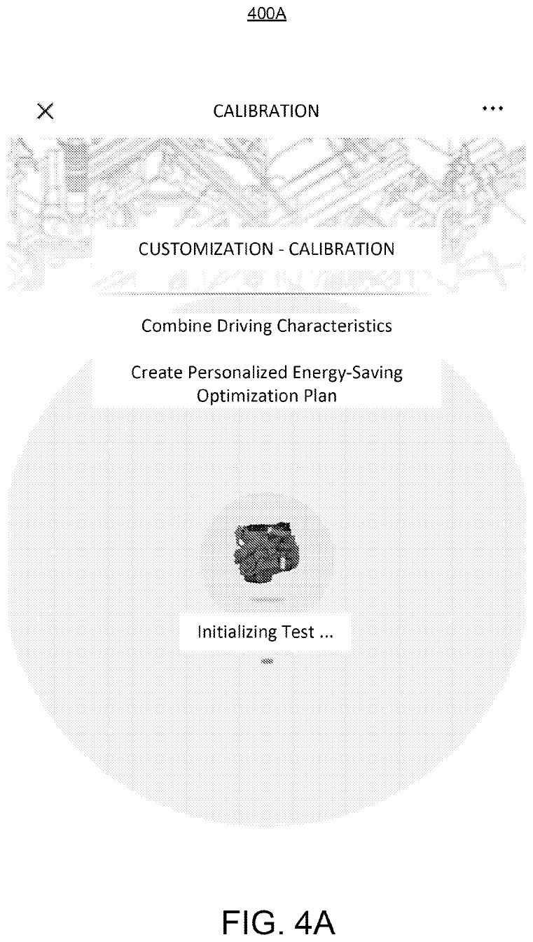

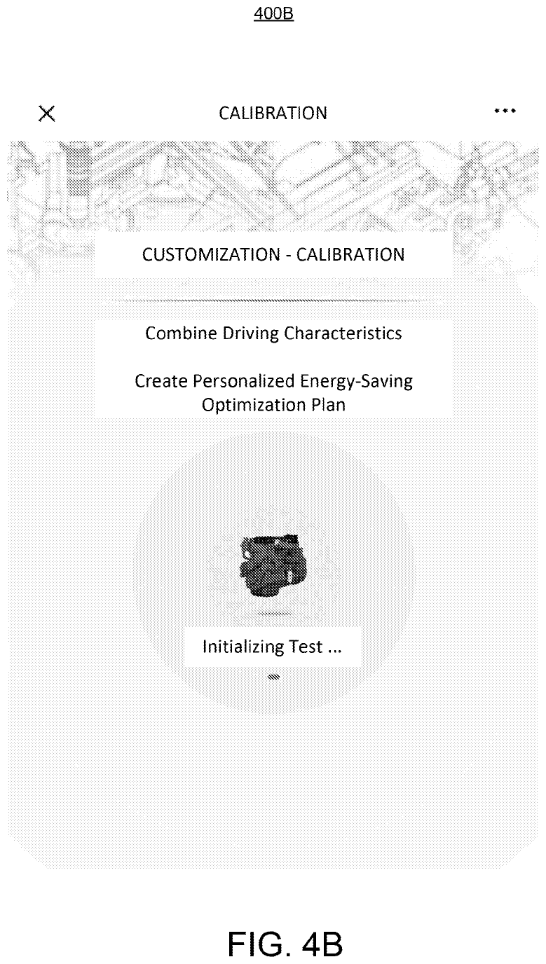

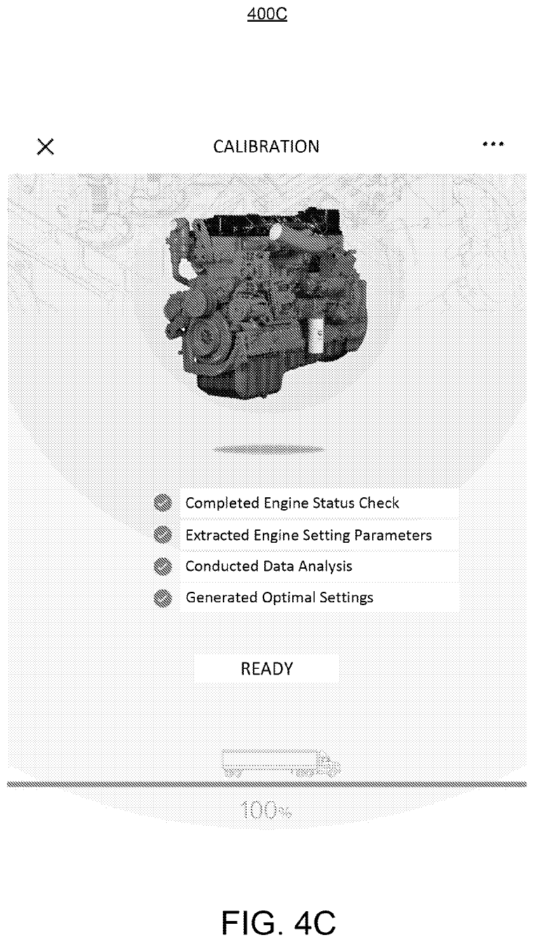

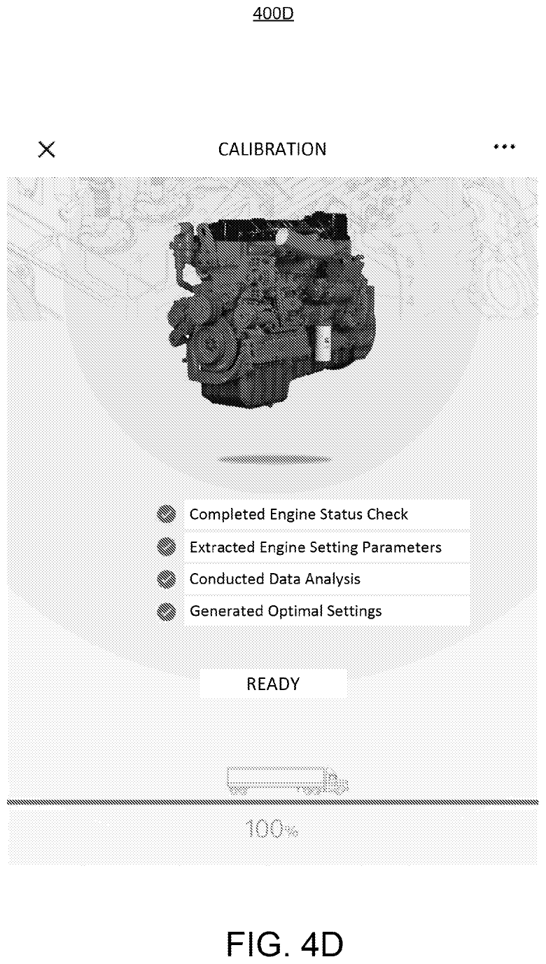

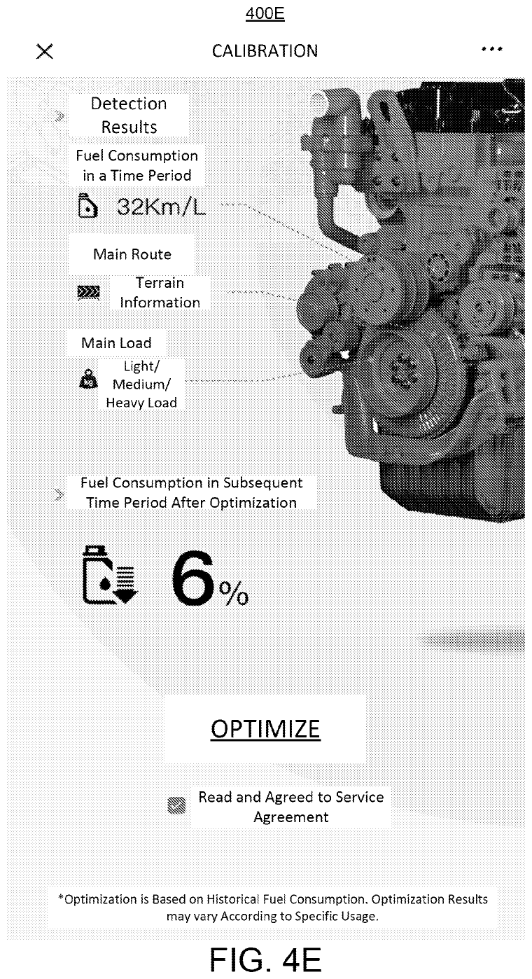

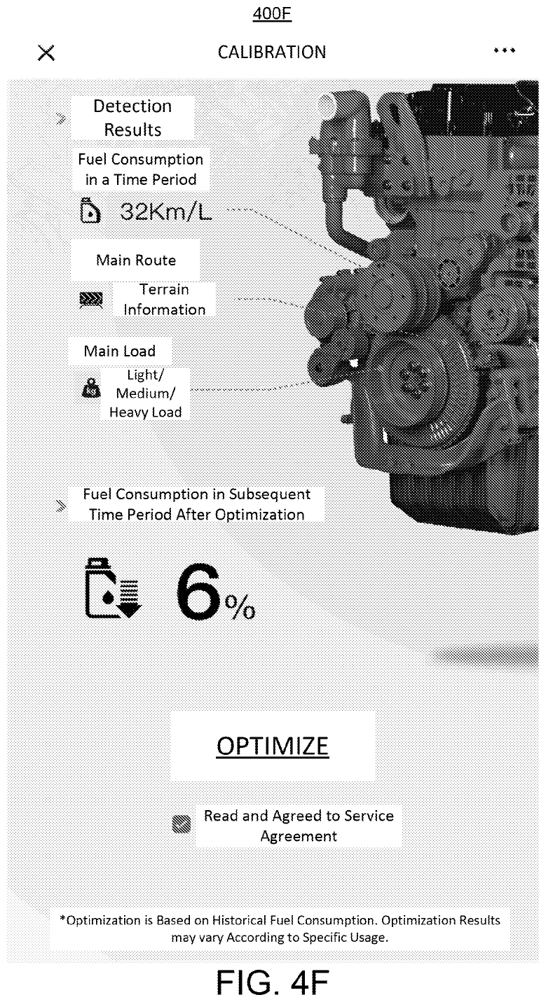

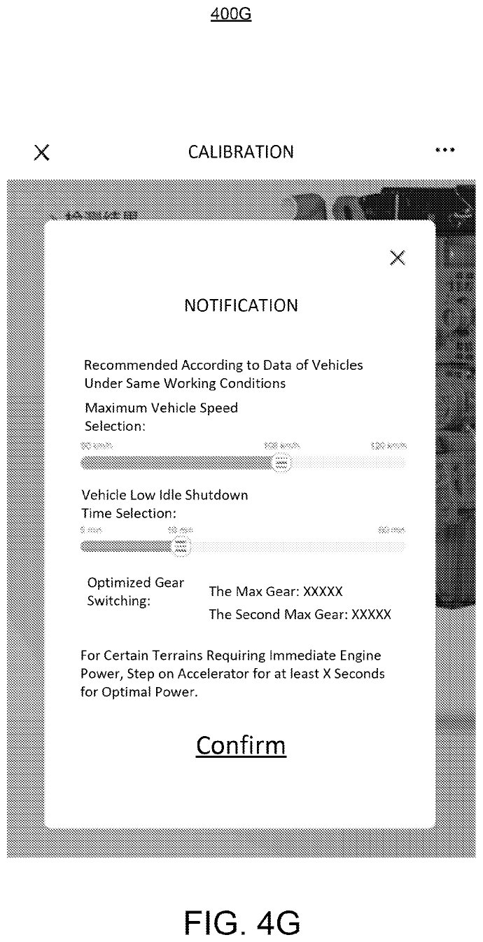

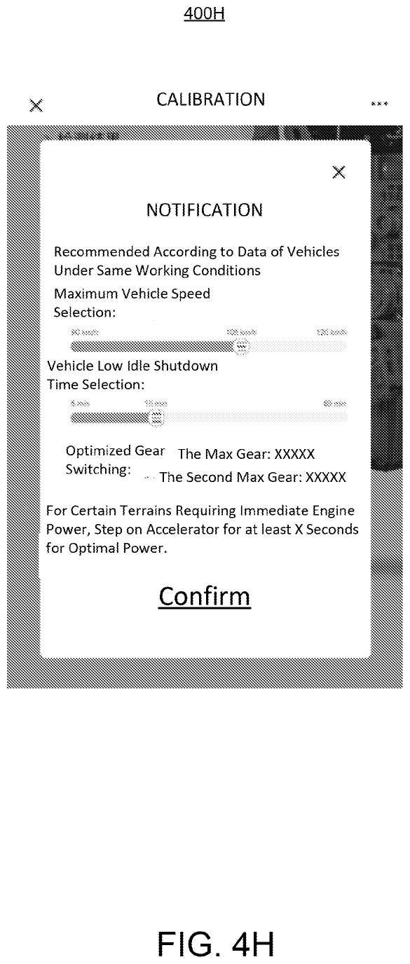

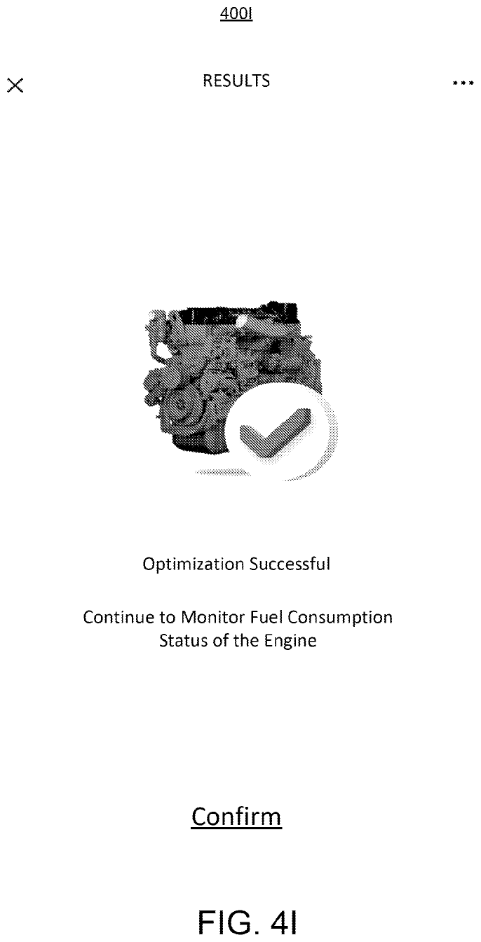

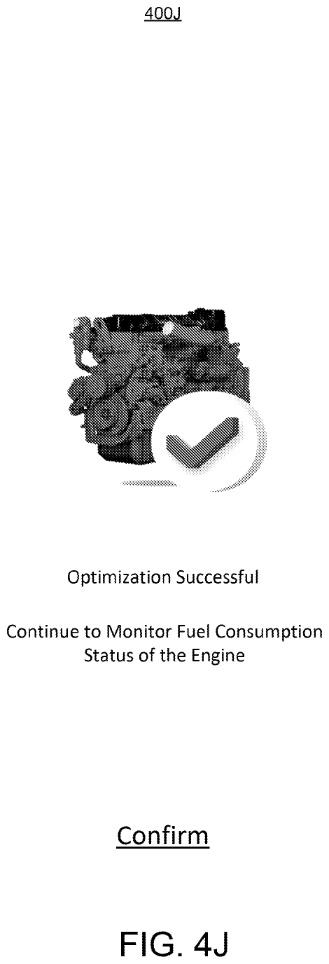

The UI circuit 230 generates a graphical user interface (GUI) for the UI device 106. In some cases, the UI circuit 230 generates different GUIs based on the calibration stage of the vehicle controller 140. For instance, the UI circuit 230 may generate a loading indication for initialization of the calibration, progress or status indication of certain initial checks and tests, vehicle information (e.g., average fuel consumption for a time period, average vehicle load, type of route typically taken, etc.), a change in operating characteristic upon adopting or integrating parameter changes, notifications (e.g., manual configuration of parameters), operating characteristic selection (e.g., performance, fuel economy, reliability, comfort, etc.), etc. The GUI may include interactive elements, such as for the user 108 to adjust desired operating characteristics or customized calibration parameters. Examples of the generated and rendered GUIs may be shown in at least FIGS. 4A-J.

At a high level, the custom calibration processing system 228 obtains a base calibration identifier 114, identifies at least one comparable vehicle based on at least one of the base calibration identifier 114 or an equipment platform identifier (e.g., an identifier regarding a type of engine 103, a type of drive train, a type of engine, etc.) and an indication of a desired operating characteristic, determines parameter(s) to adjust including calibration settings for the parameter(s) based on the identified at least one comparable vehicle, generates customized calibration information from the base calibration 114 including the adjusted parameters for replacing a portion of the vehicle information. The customized calibration information is then transmitted OTA by calibration processing system 228 to the vehicle controller 140 for replacing at least some vehicle information stored by the vehicle controller thereby transforming the structure and operation of the vehicle controller 140.

The key parameters tuning circuit 112 is structured or configured to receive a base calibration 114 or base calibration identifier for the vehicle 101. In one embodiment, the base calibration identifier 114 is received from the vehicle 101. In another embodiment, the base calibration identifier 114 is received from at least one of the UI device 106 or the third-party 110. In the example shown, the base calibration identifier 114 is received from the vehicle 101. The base calibration identifier identifies an operating software package specific to the vehicle 101. For instance, the operating software package can be generated and/or configured by the provider entity (or another entity) associated with the remote computing system 104 for the specific vehicle or for specific vehicle components (e.g., braking system, engine 103, aftertreatment system 120, etc.), which may be referred to as factory settings of the vehicle 101.

The base calibration identifier 114 may be received in response to certain events. For example, the base calibration identifier 114 is structured to be received periodically (e.g., hourly, daily, weekly, etc.), during service events (e.g., during a vehicle inspection or maintenance), in response to a shutdown and/or restart event, or when the vehicle 101 satisfies certain conditions. The conditions may include at least one of parking, turning ON the engine, or enabling network connectivity for the vehicle 101, among others. Enabling network connectivity for the vehicle 101 allows the remote computing system 104 (e.g., other devices in the network 201) to perform OTA updates to or communicate with the vehicle 101.

The key parameters tuning circuit 112 is configured or structured to collect, receive, and/or obtain vehicle information from the telematics unit 150 of the vehicle 101 or directly from the vehicle controller 140. Because the vehicle 101 may be a part of a fleet, the key parameters tuning circuit 112 may also receive or obtain vehicle information from other vehicles in the fleet (which may include information from stationary or primarily stationary equipment, such as gensets). The key parameters tuning circuit 112 may collect the vehicle information at predetermined time intervals (e.g., daily, weekly, monthly, etc.) or dynamically responsive to an event (e.g., subsequent to parking the vehicle 101). The vehicle information includes at least one of a vehicle location(s), a vehicle route(s) (e.g., route information), a vehicle type, or vehicle operating information. The route includes GPS information or data from a navigation system on-board or used by the operator of (e.g., UI device 106 or operator I/O device 130) the vehicle 101. The vehicle type (or operating type) includes one of at least one of a type of vehicle, such as an excavator, a crane, a semi-truck, a sedan, a truck, a power generator, and/or any other vehicle type. The vehicle type may also include an indication of a make and model of the vehicle (production year, etc.). The vehicle operating information includes information regarding operation of the vehicle, such as a vehicle speed at a particular time, over a route, etc.; an engine speed at a particular time, over a route, etc.; fuel consumption information at a particular time, over a route, etc.; transmission information (e.g., most common transmission setting, number of transmission shifts, etc.) at a particular time, over a route, etc.; temperature information at a particular time, over a route, etc. (e.g., coolant temperature, aftertreatment system component temperatures such as catalyst bed temperatures, engine temperatures, charge air temperature, exhaust gas temperature, etc.); pressure information (e.g., charge pressure); fluid flow rate information at a particular time, over a route, etc. (e.g., exhaust gas flow, etc.); etc.

The key parameters tuning circuit 112 is also structured or configured to receive information (e.g., first information) from the third-party 110 (e.g., weather information, traffic status information, market requirement information, etc.). The weather information may include a forecast within a predetermined time frame (e.g., 1-day, 5 days, 10 days, etc.) of humidity, temperature, wind speed, precipitation, among others. The traffic status information may include an indicator regarding congestion (e.g., a flow of traffic associated with a certain time of day), roadblocks, constructions, obstructions (e.g., traffic accident), etc. The market requirement information may include information regarding an operating market for the vehicle, such as at least an emissions requirement (e.g., NOx, PM, GHG, etc.), an engine braking requirement, a noise requirement, a cost of electricity, a location of battery charge stations, etc. The first information may be specific to the vehicle 101 operating conditions, such as a predefined route of the vehicle 101, an expected or predicted route of the vehicle 101, when the vehicle 101 will be or will likely be in a certain area or region, etc. The region may experience certain dynamic information (information that changes a function of time), such as traffic status information and weather information. The region may also have certain static information (information that predominately does not change with time), such as road terrain information. The route and time that the vehicle 101 may experience the region may be predefined from the vehicle 101 (e.g., via operator I/O device 130), from the third-party (e.g., the third-party may be a fleet operator for the vehicle 101 and the third-party computing system provides information regarding an expected travel and time of travel for the vehicle 101 to the remote computing system 104), from the UI device 106, and/or a combination thereof.

In some cases, the key parameters tuning circuit 112 obtains information associated with various vehicles (e.g., including the vehicle 101 or other vehicles) from the third-party 110. The key parameters tuning circuit 112 can compare vehicle information of the vehicle 101 to other vehicles to determine comparable vehicles (e.g., similar or related vehicle(s) or population). In this regard, the remote computing system 104 may store information regarding operation and other vehicle information for a plurality of vehicles.

The key parameters tuning circuit 112 is structured to identify related or similar vehicle(s) in a variety of ways. For instance, the related vehicle may be defined as at least one of a vehicle within the same geographical location (e.g., within a predefined radius of the vehicle 101, such as 100 miles), a vehicle that has the same or similar vehicle type (e.g., two trucks, two sedans, two excavators, etc.), a vehicle that has the same or similar operation condition (e.g., similar max or average vehicle speed, mileage, route traveled, etc.), a vehicle that has a desired operating characteristic (e.g., emissions below a certain threshold, etc.), a combination thereof, etc. The types (e.g., category of information) or the number of correlations between vehicles can be configured by the administrator of the remote computing system 104, for example. In some cases, the similar vehicles can include or refer to vehicles with similar equipment platforms (e.g., same or similar engine platform of engine type, drivetrain platform, driveline components, etc.). The similar vehicles may also be determined based on a similarity of application (e.g., excavators, line-haul trucks, etc.).

The key parameters tuning circuit 112 is configured or structured to identify and/or receive a desired operating characteristic (e.g., optimization goal or parameter configuration to achieve certain operating status) for the vehicle 101, such as from one or more inputs from the UI device 106 or operator I/O device 130 (e.g., provided by the user 108 or vehicle operator), from the third party 110 (e.g., a desired operating characteristic for the vehicle 101 and fleet vehicles as provided by the fleet operator/manager), and/or a combination thereof. The desired operating characteristic may be specific to a certain geographical location, a route, a season, a time of operation (e.g., 5 PM to 12:00 PM versus 12:00 AM to 5:00 PM), a combination thereof, etc. As described above and with respect to fuel cell implementations, the desired operating characteristic may be a reduction in hydrogen consumption, such that the parameters may be associated with improved motor control that reduces reliance on hydrogen. The desired operating characteristic can include, but is not limited to, one or more of at least improved fuel economy, a reduction in exhaust gas emissions of a certain exhaust gas constituent, an increased usage of an electric motor in place of an internal combustion engine, a reduction in transmission shift events, a preference for additional power instead of reduced emissions, a preference to minimize route travel time, etc. To achieve the desired operating characteristic(s), the key parameters tuning circuit 112 is configured or structured to search data from/associated with the at least one comparable vehicle (e.g., used as a reference) to identify a best of the desired characteristic (e.g., most optimal fuel economy, lowest exhaust gas emissions, etc.) of the comparable at least one vehicle to tune parameter(s) of the vehicle 101. For example, the key parameters tuning circuit 112 may identify a plurality of trim parameters or k parameters associated with the identified comparable vehicle based on the desired operating characteristic. The parameters can be at least user operation related (e.g., transmission shifting, braking, etc.), engine control related (e.g., combustion control, emission control, etc.), and/or device control related (e.g., high vehicle speed limit, cooperation with automated manual transmission (AMT), air conditioner (A/C), etc.) parameters. The parameters can include or correspond to calibration parameters or trim parameters.

In operation and in one embodiment, the key parameters tuning circuit 112 is structured to retrieve a calibration identifier associated with the comparable vehicle to determine one or more configurations or settings of the parameters used by the comparable vehicle to achieve or attempt to achieve the particular desired operating characteristic. In some embodiments, the base calibration identifier may be different between the vehicle 101 and comparable vehicles. In this case, the similar vehicle (as described above) may be identified based on at least one of the same equipment platform (e.g., engine platform, drive train, etc.), similar application, etc. These parameters, which may include trim and/or calibration parameters, may be referred to as “optimized parameters”. As such, the key parameters tuning circuit 112 can indicate/provide at least one optimized parameter to the customized calibration circuit 116 for tuning, calibrating, upgrading, improving, and/or enhancing operation of one or more components of vehicle (e.g., engine 103, vehicle controller 140, aftertreatment system 120, etc.). The key parameters tuning circuit 112 tunes specific parameters of the vehicle 101 at a predetermined time interval (e.g., monthly, weekly, etc.) or responsive to an event (e.g., starting a route, navigating through a historical or new route, etc.) using aggregated historical data (e.g., a week, a month, etc. of data) of the vehicle 101 and/or other vehicles.

Thus, the key parameters tuning circuit 112 is structured to tune (e.g., adjust, modify, change, update, etc.) parameters of the vehicle 101 when unoptimized for a received desired operating characteristic based on a comparison to comparable vehicles. In some cases, the vehicle 101 may be optimized for the specific operating characteristic based on a comparison to other comparable vehicles. For example, the vehicle 101 may correspond with an emissions level of X NOx in a certain region while the comparable vehicle corresponds with an emissions of X-Y NOx in the certain region. Thus, the key parameters tuning circuit 112 may determine that the vehicle 101 is not operating as desired or as potentially possible relative to the comparable vehicle.

In some cases, the key parameters tuning circuit 112 utilizes a machine learning model to train a model. The model may be based on artificial intelligence, one or more processes/algorithms/equations/etc., a combination thereof, and so on. The model may be specific to the vehicle 101 or a group of vehicles (e.g., similar vehicle type, location, route, etc.). The key parameters tuning circuit 112 trains the model using information from various comparable vehicles, such as to correlate certain calibration parameter(s) to a specific operating characteristic. The key parameters tuning circuit 112 can input or receive vehicle information of the vehicle 101 to identify adjustment to any parameter to achieve the desired operating characteristic, for example.

The customized calibration circuit 116 is configured or structured to receive or obtain tuned parameter(s) from the key parameters tuning circuit 112. For example, the custom calibration circuit 116 may receive the optimized parameter(s) from identifying these parameters with the comparable vehicle or generate optimized parameters using a model, formula, etc. as described above. The customized calibration circuit 116 is configured to generate customized calibration information, also referred to as a custom calibration package or payload, specific to the vehicle 101 based on at least the information from the key parameters tuning circuit 112 (e.g., tuned or optimized trim parameters or key parameters). In operation, the customized calibration circuit 116 is structured to generate the customized calibration information by modifying at least a portion of the base calibration information (e.g., base trim and calibration parameters obtained/retrieved using the base calibration identifier 114 specific to the equipment platform (e.g., engine platform, such as engine type) of the vehicle 101), such as tuning one or more of the base parameters optimized for a desired operating characteristic. In some cases, the customized calibration circuit 116 may create a payload, packet, or data storage including at least a list of operating characteristics and one or more key parameters associated with a respective operating characteristic, among other information for tuning or calibrating vehicles. The customized calibration circuit 116 can save a copy of the information in the memory device 226 or remote data repository device communicatively coupled to the network 201.

The customized calibration circuit 116 transmits the customized calibration information or package to the vehicle 101 (e.g., the system 102) to replace at least a portion of the vehicle information. For instance, the vehicle 101, upon receiving or downloading the customized calibration information, adjusts or modifies one or more parameters (or other vehicle information) of the vehicle controller 140 to perform a respective action (e.g., reduce A/C operation to minimize fuel consumption, change a shift schedule for a transmission to reduce shift events,, modifying braking coefficient for adjusting braking force, reducing an acceleration rate capability to improve fuel economy during traffic congestion, etc.). In some cases, the vehicle 101, via the vehicle controller 140, can upload feedback data to the remote computing system 104 regarding performance of the vehicle 101 relative to the desired operating characteristic. In which case, the key parameters tuning circuit 112 can re-tune certain parameter(s) using the trained model or data from a different comparable vehicle to attempt to further obtain achievement of the desired operating characteristic.

In some cases, prior to transmitting the customized calibration package to the vehicle 101 over the network, the customized calibration circuit 116 can provide customized calibration information to the vehicle 101 and/or the UI device 106 as a recommendation or suggestion. The UI device 106 receives an input from the user interacting with an interactive element, such as a confirmation of the calibration, adjustment to the customized calibration information, cancellation of calibration, etc. The UI device 106 may provide or modify the desired operating characteristic, such that the key parameters tuning circuit 112 can re-tune or recalibrate one or more parameters similar to and/or different from prior parameters.

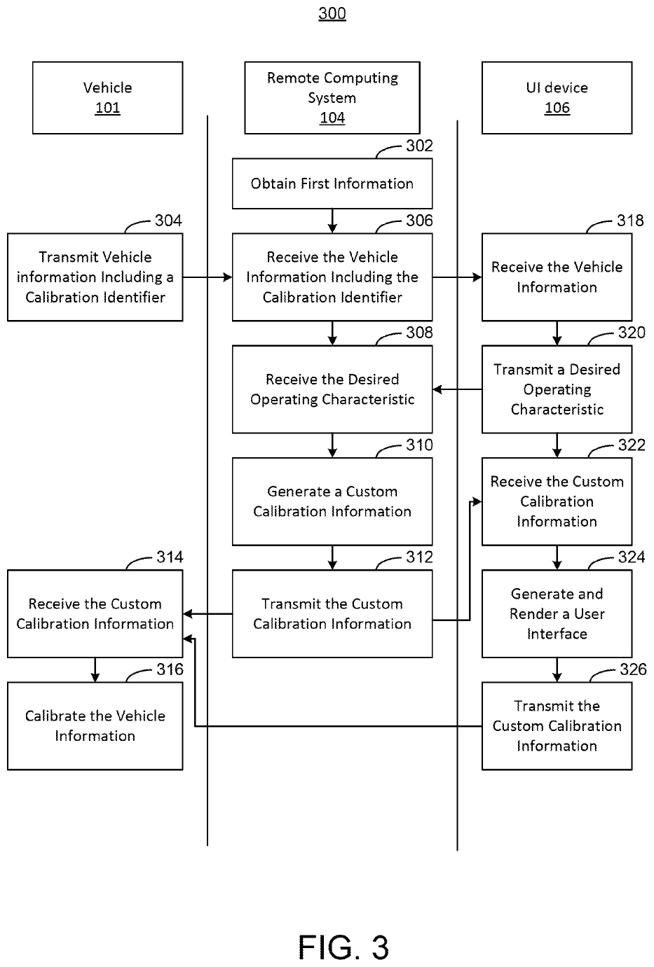

Referring now to FIG. 3, a method 300 for generating and providing customized calibration information to a vehicle is shown, according to an exemplary embodiment. The method may be performed by the components of FIGS. 1-2, such that reference may be made to them to aid explanation of the method 300.

At process 302, the remote computing system 104 obtains information (e.g., first information) from the third-party 110. As described herein above, the first information can include at least one of a weather input, traffic information for the vehicle, or a market requirement. The market requirement can include emission exhaust gas emissions requirement, engine braking requirement, engine noise requirement, etc., which is accounted for when tuning one or more parameters. For instance, the remote computing system 104 may not adjust certain parameters that surpass a noise level threshold, emission threshold, etc. based on data from comparable vehicles which does not satisfy the market requirement.

At process 304, the vehicle 101 (e.g., the vehicle controller 140 or the telematics unit 150) transmits vehicle information of the vehicle 101 to the remote computing system 104. The vehicle information includes a calibration identifier. The vehicle information may also include at least one of a vehicle location, vehicle route, a vehicle type, or vehicle operating information, among others. The calibration identifier may be a numeric, alphanumeric, alpha, or any other type of structure/construct that identifies an operating software package specific to the vehicle 101 (and controller 140, or at least one controller of the vehicle if there are multiple controllers with multiple operating software packages/systems). By only transmitting the base calibration identifier, as compared to the whole package (e.g., operating software (OS)+calibration and trim parameters), there is a reduction in occupied bandwidth, since an identifier is smaller in data size compared to a whole packet of calibration information. Hence, using calibration identifiers identifying the operating software package increases a transmission speed, reduces reliance on continued network connectivity for a sustained amount of time, and improves security for the remote computing system 104, the vehicle 101, the third-party 110, and/or the UI device 106. For instance, fraudsters are unlikely to know the settings of the vehicle controller when using only the identifier. The identifier is a value that may be of no value without the corresponding database that links it to/identifies OS packages, which is stored by the remote computing system 104.

In one embodiment, the calibration identifier or base calibration identifier is specific to the engine of the vehicle 101 (e.g., the engine platform). Vehicles with a similar engine type can include similar or the same base calibration identifiers, for example. In some cases, the calibration identifier may include or be referred to as an operating software identifier or package identifier identifying a calibration package. The calibration package stores/holds specific parameters (e.g., also referred to as key parameters, k-parameters, trim parameters, or calibration parameters) for the vehicle 101.

At process 306, the remote computing system 104 receives the vehicle information from the vehicle 101 including the calibration identifier, responsive to the transmission at process 306. The remote computing system 104 uses the identifier to retrieve calibration information (i.e., base calibration information) of the vehicle 101 (e.g., stored by the remote computing system 104). The base calibration information includes at least the operating software specific to the equipment platform of the vehicle 101 and base parameters (e.g., configured by manufacturer, installed by default during production, etc.). The base parameters can include trim parameters and/or calibration parameters.

At process 308, the remote computing system 104 receives a desired operating characteristic (or an indication of such) for the vehicle 101 (e.g., from the vehicle 101, from the UI device 106, from the third party 110, a combination thereof, etc.). The desired operating characteristic includes at least one of an improvement in fuel economy, a reduction in exhaust gas emissions of a certain exhaust gas constituent, an increased usage of an electric motor in place of an internal combustion engine (e.g., in a hybrid powertrain to reduce fuel consumption), a reduction in transmission shift events, a combination thereof, among other desired operating characteristics. In some cases, the desired operating characteristic may be predetermined by the remote computing system 104 based on the vehicle information (e.g., to optimize certain parameter(s) to improve an operating characteristic that is underperforming compared to comparable vehicles or to satisfy a market requirement.

At process 310, the remote computing system 104 generates custom calibration information based on the first information from the third-party 110 and the vehicle information. For example, the remote computing system 104 receives a calibration identifier (e.g., base calibration identifier 114) of the vehicle 101. The remote computing system 104 identifies at least one similar vehicle (e.g., comparable vehicle) based on the base calibration identifier 114 (or information associated with the base calibration identifier 114), such as vehicles with similar parameters (e.g., base parameters), equipment platform, vehicle type (e.g., truck, sedan, power generator, etc.), application (e.g., mining, freeway driving, etc.), or other vehicle information. Based on the identified similar vehicles, the remote computing system 104 identifies and selects at least one vehicle that is operating in a desired manner relative to the desired operating characteristic (e.g., vehicle having the best emission characteristic, fuel economy characteristic, etc.). In response to identifying at least one similar vehicle with the desired manner of operation, the remote computing system 104 identifies at least a subset of parameters (e.g., aftertreatment system control parameters for emission characteristic, transmission parameters for fuel economy, etc.) from the identified vehicle. The subset of parameters may be trim parameters and/or calibration parameters, which are packaged together in the custom calibration package or information. Accordingly, the remote computing system 104 identifies one or more parameters (e.g., key parameters) from the similar vehicle to use for the vehicle 101. The custom calibration information is specific to (or for use by the vehicle 101 to achieve) the desired operating characteristic for the vehicle 101.

The custom calibration information includes specific parameters based on the calibration identifier of the vehicle 101. For example, the calibration identifier may identify an operating software logic and describe parameters, calibration and trim, that are capable of adjustment. In this regard, some calibration packages may host different, more, and/or less parameters than other calibration packages. For example, a calibration package for an excavator may include parameters for controlling the backhoe (e.g., hydraulic fluid pressure for a given lever position, maximum allowed range of movement, etc.) where such parameters are not included in a truck calibration package.

The specific parameters include at least one of user operation parameters, engine control parameters, or vehicle device parameters, etc. The user operation parameters include at least transmission shifting, braking, among other driving-related behavior information. The engine control parameters include at least combustion control related (e.g., fuel injection quantity/timing, engine speed, engine torque, maximum power output, valve positions, etc.), emission related optimization (e.g., regeneration event schedule, reductant dosing strategy, aftertreatment system heater operation control, etc.), etc. The vehicle device parameters include vehicle speed limit, cooperation with AMT, A/C, or other systems on the vehicle 101.

In some cases, the custom calibration information is also specific to a condition received regarding for the vehicle. The condition may include information from at least one of the vehicle 101 or the third-party 110, such as a defined route for the vehicle, a load for the vehicle, a region of travel for the vehicle, a season of travel for the vehicle, an altitude of travel for the vehicle, among others. The remote computing system 104 tunes the custom calibration information to account for the condition using at least the similar vehicle as a reference for adjusting the parameters (e.g., identify the at least one similar vehicle using similar route, experienced similar weather, etc., and adjust certain key parameters similar to the similar vehicle). In some cases, the remote computing system 104 adjust parameters using a machine learning model trained using data from various vehicles or fleets. For instance, information pertaining to similar vehicles is aggregated and compared to the vehicle information of the vehicle 101 to determine parameter(s) to adjust and magnitude of adjustment.

The remote computing system 104 performs at least one of a dynamic parameters change, partial calibration update, or whole calibration update for the vehicle 101 in response to identifying the at least one similar vehicle including one or more key parameters to achieve the desired operating manner. In some cases, the remote computing system 104 performs at least one of the change or update in response to a change in the route, weather condition, or other events that may affect vehicle performance during a trip. Dynamic parameters change involves real-time or periodic changes to certain key parameters (calibration and/or trim) in the calibration package for the vehicle 101. The partial calibration update includes periodic updates of a subset of software components in the calibration (e.g., calibration and/or trim parameters). The whole calibration update includes real-time or periodic updates of the whole software components of the vehicle 101 (e.g., the operating software package along with the calibration and trim parameters).

At process 312, the remote computing system 104 transmits the custom calibration information to the vehicle 101 over the network 201. The remote computing system 104 may transmit the custom calibration information in response to receiving an indication of the operator or user 108 accepting to initialize the calibration (e.g., from UI device 106) or responsive to generating the custom calibration information.

At process 314, the vehicle 101 receives the custom calibration information from the remote computing system 104 over the network 201.

At process 316, upon receiving the custom calibration information, the vehicle 101, via the vehicle controller 140, updates the vehicle information (particularly, the parameters and/or entire calibration package) in the vehicle controller 140. In particular, the vehicle controller 140 causes the custom calibration information to replace at least a portion of the vehicle information stored in at least one vehicle controller 140 of the vehicle 101. For instance, the vehicle controller 140 is structured to update, modify, and in particular replace certain parameters with the received parameters (e.g., at least a subset of the received parameters) in the custom calibration package that may be different from the stored parameters. The received parameters are intended to help attain certain operating characteristics, such as selected by the operator or predetermined for the vehicle 101. The custom calibration package includes instructions that cause the transmitted parameter to override the stored parameters. In some cases, in response to comparing the received and stored parameters, the vehicle controller 140 may determine that the parameters (or at least some of the compared parameters) are the same (e.g., same settings and configurations). In this case, the vehicle controller 140 may not perform an action. In some other cases, the remote computing system 104 can perform the comparison of the parameters stored in the vehicle controller 140 to the parameters to be configured on the vehicle 101. Based on the comparison, the remote computing system 104 transmits the parameters (or a subset of key parameters) for overriding or replacing existing parameters stored on the vehicle controller 140. In some other cases, if the compared parameters are the same, the remote computing system 104 may opt not to transmit the parameters.

In some implementations, the vehicle controller 140 have certain authentication or authorization requirements to prevent modification. For instance, the vehicle controller 140 stores policies, rules, or indications (e.g., configured or installed by the manufacturer, etc. of the vehicle 101) of one or more parameters not to modify or replace. In this case, the vehicle controller 140 may not modify the parameters indicated in the policy. In some cases, the authentication or restriction may be lifted by an operator with a valid authentication code or the manufacturer via an OTA update, for example. The authorization requirements may be embedded or established for one parameter, a subset of parameters, or all parameters, in some cases. In these implementations, the remote computing system 104 sends custom calibration package with instructions including authorization credentials (e.g., passcode, etc.) to enable the received parameters to over-write the stored parameter.

At process 318, the UI device 106 receives vehicle information including a calibration identifier of the vehicle 101 over the network 201 from one of the vehicle 101 or the remote computing system 104. Throughout the processes of the UI device 106, the UI device 106 can generate and render a GUI based on information received from the vehicle 101 and/or the remote computing system 104. The UI device 106 can generate a GUI displaying the vehicle information to the operator.

At process 320, the UI device 106 transmits a desired operating characteristic for the vehicle 101 to the remote computing system 104, such as to generate the custom calibration information specific to the desired operating characteristic. For instance, the UI device 106 may generate and render a GUI indicating one or more operating characteristics for optimization by the remote computing system 104 (e.g., at process 324). The GUI can include one or more interactive elements. The UI device 106 can receive a selection of an operating characteristic or confirmation to calibrate parameters, for example.

At process 322, the UI device 106 receives custom calibration information from the remote computing system 104. At process 324, the UI device 106 can generate and render GUI including the custom calibration information and/or at least a portion of the vehicle information, for instance, to indicate parameters updated/modified for the vehicle 101, or an improvement to at least one operating characteristic of the vehicle based on at least the vehicle information and the custom calibration information. The improvement to at least one operating characteristic may be represented as a percentage, value, etc., such as an increase in efficiency, increase in fuel economy, reduction in fuel consumption for certain trips, increase in vehicle performance (e.g., acceleration or max speed), among other improvements to the vehicle operation.

The GUI may include other information, including, but not limited to average fuel consumption, vehicle acceleration, changes to the vehicle 101 (e.g., improvements in vehicle operation) shown as delta or ranking changes (e.g., grade C to grade B, B to A, etc.), user instruction content (e.g., instructions operator to perform), agreements and warning information for calibration, or one or more interactive elements. The interactive element includes at least one of a confirmation element (e.g., to confirm the calibration operation or certain changes to the vehicle 101), a parameter tuning element (e.g., to further adjust the custom calibration information), a feedback element (e.g., provide feedback to the remote computing system 104 or administrator), or a support element (e.g., sends a signal requesting support from an agent, representative, or administrator).

Examples of the GUI may include the user interfaces shown in at least FIGS. 4A-J. UIs 400A, 400C, 400E, 400G, and 400I include English translation for the corresponding UIs 400B, 400D, 400F, 400H, and 400J, respectively. Referring to FIGS. 4A-J, the UIs 400A-J include interactive elements, such as an option icon (e.g., although located in the top right as shown, the icon among other elements can be located in any position of the GUI) and an exit icon (e.g., to cancel the operation or exit the GUI). UIs 400A-B illustrates an initialization phase for vehicle calibration. UIs 400C-D illustrates various statuses of operations conducted, such as checking engine status (e.g., or other vehicle information), extracting engine setting parameters (e.g., base calibration identifier associated with the vehicle 101), performing data analysis (e.g., analyzing vehicle information, data of at least one similar vehicle, data from the third-party 110, etc.), and generating optimal settings (e.g., custom calibration information including key parameters).

UIs 400E-F illustrates one or more vehicle information detected from the engine status check, such as fuel consumption, main route (e.g., type of terrain vehicle operates in on average), load experienced by the vehicle (e.g., ranges of weight carried by the vehicle 101), and a determined change in operating characteristic (e.g., in this case, 6% reduction in fuel consumption or improvement in fuel economy). Further, UIs 400E-F include interactive elements for initiating the optimization and an agreement to the service. UIs 400G-H illustrates a notification, pop-up, or a second window for tuning one or more parameters (e.g., part of the custom calibration information or key parameters). The UIs 400G-H include a vehicle low idle shutdown time selection. The operator may interact with the notification to further tune the key parameters. UIs 400I-J illustrates the results of the calibration or optimization. In this case, the optimization is successful, such as successfully downloaded by the vehicle 101, installed to one or more vehicle components, etc. Otherwise, if unsuccessful, the UI may indicate an unsuccessful optimization and provide the operator with an option to re-initiate the calibration.

At process 326, and in some implementations, the UI device 106 transmits the custom calibration information to the vehicle 101. For instance, upon confirming to calibrate or adjusting the custom calibration information, the UI device 106 can be the transmitter of the custom calibration information to the vehicle 101. In some cases, the UI device 106 sends a signal to the remote computing system 104 (e.g., confirmation or acknowledgment) to transmit the custom calibration information.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A “coupled” to circuit B may signify that the circuit A communicates directly with circuit B (i.e., no intermediary) or communicates indirectly with circuit B (e.g., through one or more intermediaries).

While various circuits with particular functionality are shown in FIG. 2, it should be understood that the vehicle controller 140 and the remote computing system 104 may include any number of circuits for completing the functions described herein. For example, the activities and functionalities of the processing circuit 202 or processing circuit 220 may be combined in multiple circuits or as a single circuit. Additional circuits with additional functionality may also be included. Further, the vehicle controller 140 and/or remote computing system 104 may further control other activity beyond the scope of the present disclosure.

As mentioned above and in one configuration, the “circuits” may be implemented in machine-readable medium for execution by various types of processors, such as the processor 204 or 224 of FIG. 2. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

Accordingly, the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A computing system coupled to at least one vehicle, the computing system comprising:
a processing circuit comprising one or more processors coupled to one or more memory devices storing instructions therein that, when executed by the one or more processors, cause the processing circuit to:
obtain, from a third-party remote computing system, first information;
receive, from a vehicle, vehicle information comprising a calibration identifier;
generate, based on the first information and the vehicle information, custom calibration information; and
transmit, over a network, the custom calibration information to the vehicle that replaces at least a portion of the vehicle information stored in at least one vehicle controller of the vehicle.

2. The computing system of claim 1, wherein the instructions, when executed by the one or more processors, further cause the processing circuit to:
receive, from a client computing device associated with the vehicle, a desired operating characteristic for the vehicle; and
generate the custom calibration information specific to the received desired operating characteristic for the vehicle.

3. The computing system of claim 2, wherein the desired operating characteristic comprises at least one of an improved fuel economy, an increased usage of an electric motor in place of an internal combustion engine, or a reduction in transmission shift events.

4. The computing system of claim 2, wherein the desired operating characteristic is received from the at least one vehicle controller storing the vehicle information.

5. The computing system of claim 1, wherein the custom calibration information is specific to a condition received for the vehicle.

6. The computing system of claim 5, wherein the condition comprises at least one of a defined route for the vehicle, a load for the vehicle, a region of travel for the vehicle, a season of travel for the vehicle, or an altitude of travel for the vehicle.

7. The computing system of claim 1, wherein the calibration identifier is a base calibration identifier identifying an operating software package specific to the vehicle.

8. The computing system of claim 7, wherein the base calibration identifier is specific to an engine of the vehicle.

9. The computing system of claim 1, wherein the custom calibration information includes specific parameters based on the calibration identifier, the specific parameters comprising at least one of user operation parameters, engine control parameters, or vehicle device parameters.

10. The computing system of claim 1, wherein to generate the custom calibration information, the instructions, when executed by the one or more processors, further cause the processing circuit to:
identify at least one similar vehicle based on at least one of a base calibration identifier or an equipment platform identifier and a desired operating characteristic;
identify one or more key parameters of the identified similar vehicle; and
transmit, over the network, the one or more key parameters in the custom calibration information to the vehicle.

11. The computing system of claim 1, wherein the vehicle information comprises at least one of a vehicle location, a vehicle route, a vehicle type, or vehicle operating information.

12. The computing system of claim 1, wherein the first information comprises at least one of a weather input, traffic information for the vehicle, or a market requirement.

13. A method comprising:
obtaining, by one or more processors coupled to one or more memory devices, from a third-party remote computing system, first information;
receiving, by the one or more processors, from a vehicle, vehicle information comprising a calibration identifier;
generating, by the one or more processors, based on the first information and the vehicle information, custom calibration information; and
transmitting, by the one or more processors, over a network, the custom calibration information to the vehicle that replaces at least a portion of the vehicle information stored in at least one vehicle controller of the vehicle.

14. The method of claim 13, further comprising:
receiving, by the one or more processors, from a client computing device associated with the vehicle, a desired operating characteristic for the vehicle; and
generating, by the one or more processors, the custom calibration information specific to the received desired operating characteristic for the vehicle.

15. The method of claim 14, wherein the desired operating characteristic comprises at least one of an improved fuel economy, a reduction in exhaust gas emissions of a certain exhaust gas constituent, an increased usage of an electric motor in place of an internal combustion engine, or a reduction in transmission shift events.

16. The method of claim 14, wherein the desired operating characteristic is received from the at least one vehicle controller storing the vehicle information.

17. The method of claim 13, wherein the custom calibration information is specific to a condition received for the vehicle, and wherein the condition comprises at least one of a defined route for the vehicle, a load for the vehicle, a region of travel for the vehicle, a season of travel for the vehicle, or an altitude of travel for the vehicle.

18. A system coupled to a computing system, the system comprising:
at least one controller including a processing circuit comprising one or more processors coupled to one or more memory devices storing instructions therein that, when executed by the one or more processors, cause the processing circuit to:
transmit vehicle information regarding a vehicle comprising a calibration identifier to the computing system; and
receive, from the computing system over a network, a custom calibration information that replaces at least a portion of the vehicle information stored in the at least one vehicle controller of the vehicle, the custom calibration information based on first information obtained from a third-party remote computing system and the vehicle information.

19. The system of claim 18, wherein the custom calibration information is specific to a desired operating characteristic received from a client computing device.

20. The system of claim 19, wherein the desired operating characteristic comprises at least one of an improved fuel economy, a reduction in exhaust gas emissions of a certain exhaust gas constituent, an increased usage of an electric motor in place of an internal combustion engine, or a reduction in transmission shift events.
